(19) United States
(12) Patent Application Publication
(10) Pub. No.: US 2002/0144046 A1
(43) Pub. Date: Oct. 3, 2002

(54) Parallel SCSI-to-fibre channel gateway

(76) Inventor: William Gordon Hooper III, Orangevale, CA (US)

Correspondence Address: HEWLETT-PACKARD COMPANY, Intellectual Property Administration, P.O. Box 272400, Fort Collins, CO, 80527-2400, US

(21) Appl. No.: 09/823,512

(22) Filed: Mar. 30, 2001

(51) Int. Cl. G06F 13/38

(52) U.S. Cl. 710/316

(57) ABSTRACT

A SCSI-to-fiber channel gateway configured to permit a SCSI initiator on a parallel SCSI bus to communicate with a fiber channel target on a fiber channel transport medium. The SCSI-to-fiber channel gateway includes a front-end SCSI controller configured to operatively couple the SCSI-to-fiber channel gateway with the parallel SCSI bus, and a back-end fiber channel controller configured to operatively couple the SCSI-to-fiber channel gateway with the fiber channel transport medium. The gateway further includes a processing system coupled with the front-end SCSI controller and the back-end fiber channel controller. The processing system is configured to maintain a fiber channel identifier for the fiber channel target, and create a mapping between the fiber channel identifier and a SCSI-ID associated with the parallel SCSI bus. The SCSI-to-fiber channel gateway is configured to use the mapping when communicating with the SCSI initiator to cause the fiber channel target to logically appear to the SCSI initiator as a SCSI target located on the parallel SCSI bus.

### TECHNICAL FIELD

The present invention relates to a device and system configured to enable a SCSI initiator device coupled to a parallel SCSI bus to logically access one or more fibre channel target devices coupled to a fibre channel transport medium.

### BACKGROUND OF THE INVENTION

CPU processing power has continued to double on the average of every two years over the past twenty years. However, the performance of mass storage devices and computer bus interconnections between mass storage devices and CPUs has not increased at the same rate. As a result, performance in modem computer systems may be limited by the speed at which data can be accessed and transported between memory and peripheral devices, such as hard disk drives. In addition, computer systems may be limited by the amount of data that they can efficiently access.

The small computer system interface (“SCSI”) bus is the most widespread and popular computer bus for interconnecting mass storage devices, such as hard disks and CD-ROM drives, with the memory and processing components of computer systems. In its current state of development, SCSI may be thought of as a physical interface, characterized by parallel transmission of data on multiple lines, and also more broadly as a set of communication standards that may or may not be associated with a parallel transmission scheme. For purposes of clarity, the physical architecture and its accompanying standards will be referred to where appropriate as “parallel SCSI.”

Depending on the particular SCSI standard used, a parallel SCSI bus may interconnect 7 or 15 different mass storage devices with an internal bus within a computer system. Data transfer rates range from 2 megabytes (“Mbytes”) per second to 80 Mbytes per second in commonly employed SCSI standards.

Significant limitations result in parallel SCSI systems from the relatively small number of available bus connections. In addition, parallel SCSI bus connections are typically only accessible from a single computer system. These factors limit the amount of data available to a computer system, and the rate at which data can be transferred between a mass storage device and a computer system.

The fibre channel (“FC”) architecture and protocol for data communications has been developed in order to overcome the limitations imposed by the parallel SCSI bus architecture. When optical fibres are employed as a physical medium for providing serial transfer between computer systems and mass storage devices, an FC network can extend for ten kilometers and can transfer data between a computer system and a mass storage device at up to 200 Mbytes per second. Fibre channel technology also provides network topologies and an addressing scheme which permit configurations that are much more powerful and flexible than those available using parallel SCSI technology. Whereas the SCSI bus supports connection of up to 15 target devices, an FC network can support connection of more than 16,000,000 target devices.

Accordingly, fibre channel technology has been increasingly adopted to interconnect computer systems and mass storage devices. Although fibre channel technology offers many advantages over parallel SCSI, computer systems continue to include mass storage devices compatible only with the parallel SCSI bus, for both economical and practical reasons. One reason for this is that moving to a new technology is often more economical and effective if done in steps, instead of all at once. For example, computer users, systems designers, and systems administrators often desire to incorporate fibre channel technology as a backbone communications mechanism within the computer systems, while continuing to use SCSI-compatible mass storage devices. To accommodate this type of mixed environment, a number of vendors have developed FC-to-SCSI multiplexers which enable fibre channel initiators to access parallel SCSI-compatible target devices, such as disk drives, tape drives and other mass storage devices, that are connected to a parallel SCSI bus.

U.S. Pat. No. 6,065,087, entitled “Architecture for a High Performance Network/Bus Multiplexer Interconnecting a Network and a Bus that Transport Data Using Multiple Protocols,” provides an example of an FC-to-SCSI multiplexer. The disclosure of that patent is incorporated herein by this reference. U.S. Pat. No. 6,065,087 discloses an FC-to-SCSI multiplexer device that enables an initiator coupled to an FC network to access a target device coupled to a parallel SCSI bus. Fibre channel host adapters are provided on the initiating side of the system, to enable connection of the multiplexer to a fibre channel network containing one or more initiator devices. The FC host adapters are coupled through various other components to one or more target-side SCSI adapters, which each control a parallel SCSI bus to which target devices are connected. The patent focuses on FC initiators accessing parallel SCSI targets, and does not appear to address the converse problem, namely enabling parallel SCSI initiators to access to target devices on an FC system.

Other existing FC-to-SCSI multiplexers are designed only to allow FC initiators to access parallel SCSI targets. These devices are of limited utility, in that the initiator side of the device works only with FC technology. The upgrade path to fibre channel using such a device requires preserving target-side parallel SCSI technology (e.g., disk drives, CD ROM drives and other storage devices) while replacing initiating-side components with FC technology. No provision is made in these devices to allow parallel SCSI initiators to access targets on an FC system.

### SUMMARY OF THE INVENTION

Accordingly, the present invention provides a SCSI-to-fibre channel gateway configured to permit a SCSI initiator on a parallel SCSI bus to communicate with a fibre channel target on a fibre channel transport medium. The SCSI-to-fibre channel gateway includes a front-end SCSI controller configured to operatively couple the SCSI-to-fibre channel gateway with the parallel SCSI bus, and a back-end fibre channel controller configured to operatively couple the SCSI-to-fibre channel gateway with the fibre channel transport medium. The gateway is configured to maintain a fibre channel identifier for the fibre channel target, and create a mapping between the fibre channel identifier and a SCSI-ID associated with the parallel SCSI bus. The gateway is further configured to use the mapping when communicating with the SCSI initiator to cause the fibre channel target to logically appear to the SCSI initiator as a SCSI target located on the parallel SCSI bus.

A similar SCSI-to-fibre channel gateway may be incorporated as part of a fibre channel storage system according to the present invention, which may further include a fibre channel transport medium and a plurality of fibre channel target storage devices coupled with the fibre channel transport medium. In this configuration, the gateway is configured to couple with a parallel SCSI bus to provide one or more initiator devices on the parallel SCSI bus with logical access to the fibre channel target storage devices, such that the fibre channel target storage devices logically appear to the initiator devices as distinct SCSI targets on the parallel SCSI bus.

The invention further includes a method of logically accessing fibre channel target storage devices coupled to a fibre channel transport medium using a SCSI initiator coupled to a parallel SCSI bus.

### BRIEF DESCRIPTION OF THE DRAWINGS

FIG. 1 is a schematic depiction of a computer system including a parallel SCSI bus.

FIG. 2 is a schematic illustration of the parallel SCSI bus topology.

FIG. 3 is a schematic depiction of an exemplary fibre channel system, including a fibre channel arbitrated loop and various fibre channel initiator and target devices coupled to the arbitrated loop.

FIG. 4 depicts an exemplary fibre channel frame.

FIG. 5 is a table comparing and contrasting the parallel SCSI architecture with the fibre channel architecture.

FIG. 6 is a schematic depiction of a mass storage system according to the present invention, including a SCSI-to-fibre channel gateway coupled between a parallel SCSI system and a fibre channel system.

FIG. 7 is a table including mapping information which may be used by the SCSI-to-fibre channel gateway shown in FIG. 6 to permit SCSI initiators to logically access fibre channel target devices.

FIG. 8 is a schematic representation of another mass storage system according to the present invention.

FIG. 9 is a flowchart depicting a method according to the present invention for logically accessing fibre channel target storage devices coupled to a fibre channel transport medium using a SCSI initiator coupled to a parallel SCSI bus.

### DETAILED DESCRIPTION OF THE INVENTION

A computer bus is a set of electrical signal lines through which computer commands and data are transmitted between processing, storage, and input/output (“I/O”) components of a computer system. The small computer system interface (“SCSI”) I/O bus is the most widespread and popular computer bus for interconnecting mass storage devices, such as hard disks and CD-ROM drives, with the memory and processing components of computer systems. SCSI is defined in three major standards: SCSI-1, SCSI-2 and SCSI-3. The SCSI-1 and SCSI-2 standards are published in the American National Standards Institute (“ANSI”) standards documents “X3.131-1986,” and “X3.131-1994,” respectively. The SCSI-3 standard is currently being developed by an ANSI committee. An overview of the SCSI bus architecture is provided by “The SCSI Bus and IDE Interface,” Freidhelm Schmidt, Addison-Wesley Publishing Company, ISBN 0-201-17514-2, 1997 (“Schmidt”).

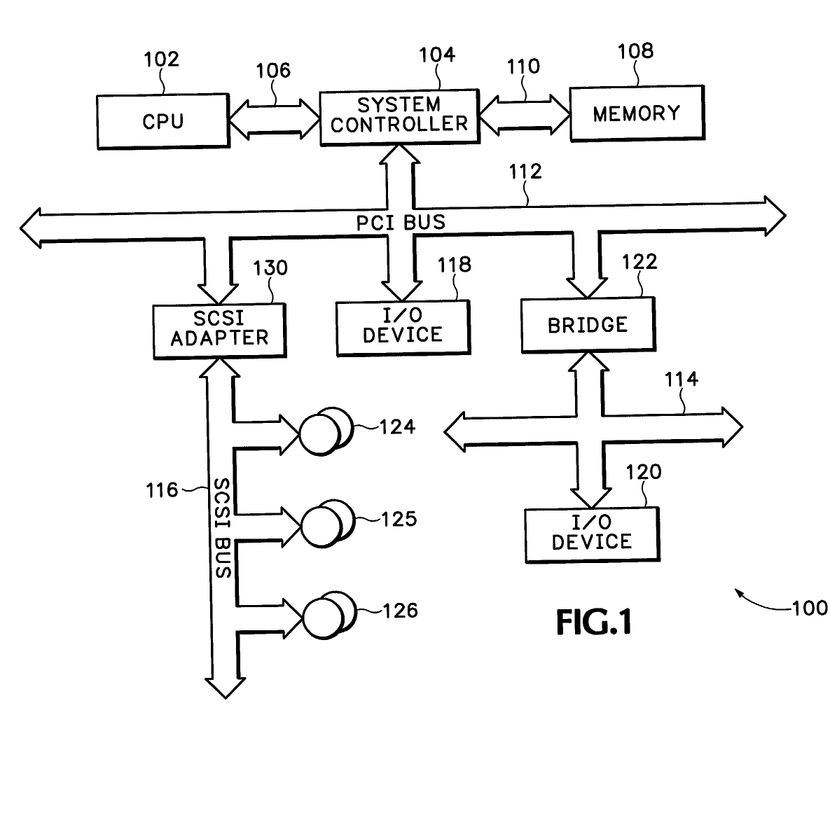

FIG. 1 is a block diagram of a common personal computer (“PC”) architecture including a parallel SCSI bus. PC 100 includes a central processing unit, or processor (“CPU”) 102, linked to a system controller 104 by a high-speed CPU bus 106. The system controller is, in turn, linked to a system memory component 108 via a memory bus 110. System controller 104 is, in addition, linked to various peripheral devices via a peripheral component interconnect (“PCI”) bus 112 that is interconnected with a slower industry standard architecture (“ISA”) bus 114 and a parallel SCSI bus 116. The architecture of the PCI bus is described in “PCI System Architecture,” Shanley & Anderson, Mine Share, Inc., Addison-Wesley Publishing Company, ISBN 0-20140993-3, 1995.

Interconnected CPU bus 106, memory bus 110, PCI bus 112, and ISA bus 114 allow the CPU to exchange data and commands with the various processing and memory components and I/O devices included in the computer system. Generally, very high-speed and high bandwidth I/O devices, such as a video display device 118, are directly connected to the PCI bus. Slow I/O devices, such as a keyboard 120 and a pointing device (not shown), are connected directly to ISA bus 114. The ISA bus is interconnected with the PCI bus through a bus bridge component 122.

Mass storage devices, such as hard disks, floppy disk drives, CD-ROM drives, and tape drives 124-126 are connected to parallel SCSI bus 116. The parallel SCSI bus is interconnected with PCI bus 112 via a SCSI-bus adapter 130. SCSI-bus adapter 130 includes a processor component and interfaces to PCI bus 112 using standard PCI bus protocols. SCSI-bus adapter 130 interfaces to parallel SCSI bus 116 using low-level physical standards and transport-type protocols, as will be described below. SCSI-bus adapter 130 exchanges commands and data with parallel SCSI controllers (not shown) that are generally embedded in each mass storage device 124-126, or SCSI device, connected to the parallel SCSI bus. The parallel SCSI controller is a hardware/firmware component that interprets and responds to SCSI commands received from a SCSI adapter via the parallel SCSI bus and that implements the SCSI commands by interfacing with, and controlling, logical devices. A logical device may correspond to one or more physical devices or to portions of one or more physical devices. Physical devices include data storage devices such as disk, tape and CD-ROM drives.

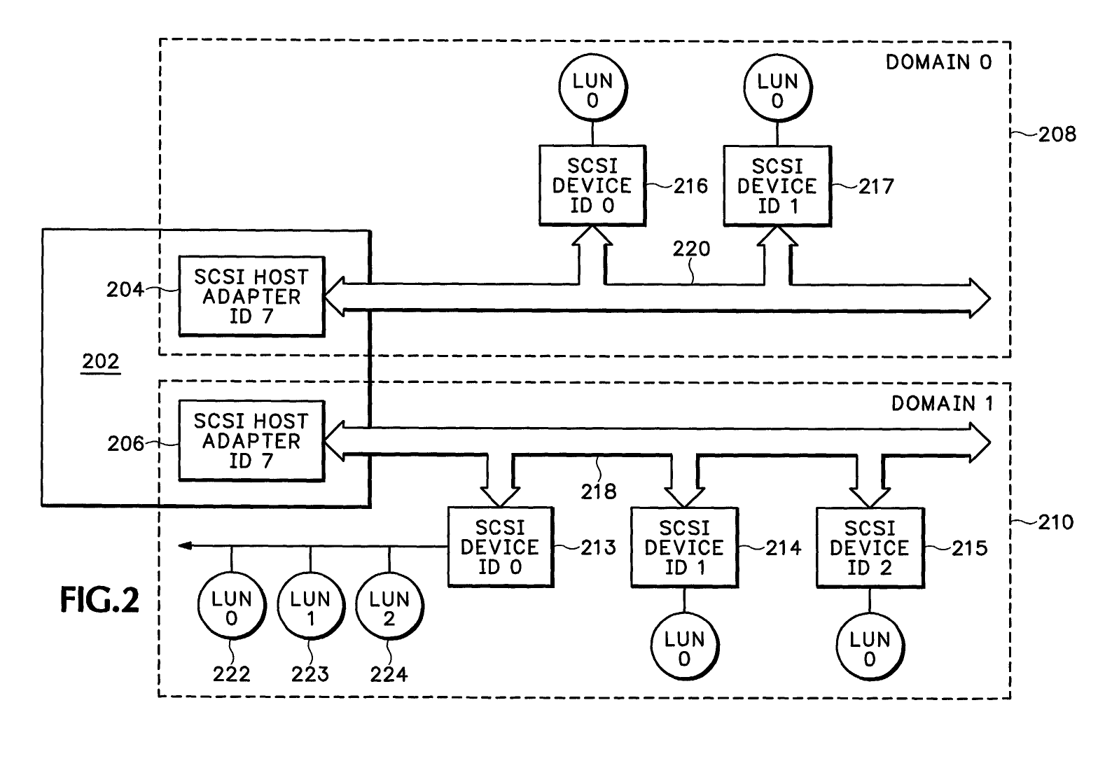

FIG. 2 illustrates a SCSI bus topology. A computer system 202, or other hardware system, may include one or more SCSI-bus adapters 204 and 206. The SCSI-bus adapter, the parallel SCSI bus which the SCSI-bus adapter controls, and any peripheral devices attached to that parallel SCSI bus together comprise a domain. SCSI-bus adapter 204 in FIG. 2 is associated with a first domain 208 and SCSI-bus adapter 206 is associated with a second domain 210. Common SCSI bus implementations allow fifteen different SCSI devices 213-215 and 216-217 to be attached to a single parallel SCSI bus. In FIG. 2, SCSI devices 213-215 are attached to parallel SCSI bus 218 controlled by SCSI-bus adapter 206, and SCSI devices 216-217 are attached to parallel SCSI bus 220 controlled by SCSI-bus adapter 204.

Each SCSI-bus adapter and SCSI device has a SCSI identification number, or SCSI-ID, that uniquely identifies the device or adapter in a particular parallel SCSI bus. By convention, the SCSI-bus adapter has SCSI-ID-7, and the SCSI devices attached to the parallel SCSI bus have SCSI-IDs ranging from 0 to 6 and from 8 to 15. A SCSI device, such as SCSI device 213, may interface with a number of logical devices, each logical device comprising portions of one or more physical devices. Each logical device is identified by a logical unit number (“LUN”) that uniquely identifies the logical device with respect to the SCSI device that controls the logical device. For example, SCSI device 213 controls logical devices 222-224 having LUNs 0, 1, and 2, respectively.

Input-output commands, or I/O commands, direct the SCSI device to read data from a logical device and write data to a logical device. An I/O transaction is the exchange of data between two components of the computer system, and is generally initiated by a processing component such as CPU 102. The I/O transaction is implemented, in part, by a read I/O command or by a write I/O command. Thus, I/O transactions include read I/O transactions and write I/O transactions. According to SCSI terminology, a device that initiates an I/O command on the parallel SCSI bus is called an initiator, and a SCSI device that receives an I/O command over the parallel SCSI bus directing the SCSI device to execute an I/O operation is called a target. The initiator-target terminology also applies to the fibre channel architecture which will be described below.

As discussed above, the parallel SCSI bus architecture suffers from various limitations. In particular, parallel SCSI bus supports a limited number of bus connections (typically 16, including the host adapter). Also, the physical distance between bus connections and the overall distance of the bus is relatively limited, with the overall distance being limited to no more than about 25 meters. In addition, the throughput on most commonly employed parallel SCSI architectures cannot exceed 80 Mbytes/second.

The fibre channel (“FC”) architecture and protocol for data communications has been developed in order to overcome the limitations imposed by the parallel SCSI bus architecture. Fibre channel is an architecture and protocol for data communication between FC ports interconnected by shielded twisted pair connections, coaxial cable, and/or optical fibres. Each FC port is associated with an FC host adapter, analogous in function to the SCSI adapters discussed above. When optical fibres are employed, an FC network can theoretically extend for up to ten kilometers. FC technology greatly reduces the connectivity and density constraints imposed by the SCSI bus architecture. A single FC host adapter can transmit data at up to 200 Mbytes per second, which is significantly higher than the throughput available in common SCSI implementations. Whereas the parallel SCSI bus typically supports connection of up to fifteen target devices, an FC network can support connection of more than 16,000,000 target devices. By vastly increasing target addressability and the physical distances from the computer system at which target devices can be located, FC networks can significantly reduce or even eliminate the data accessability constraints currently imposed by the SCSI bus architecture.

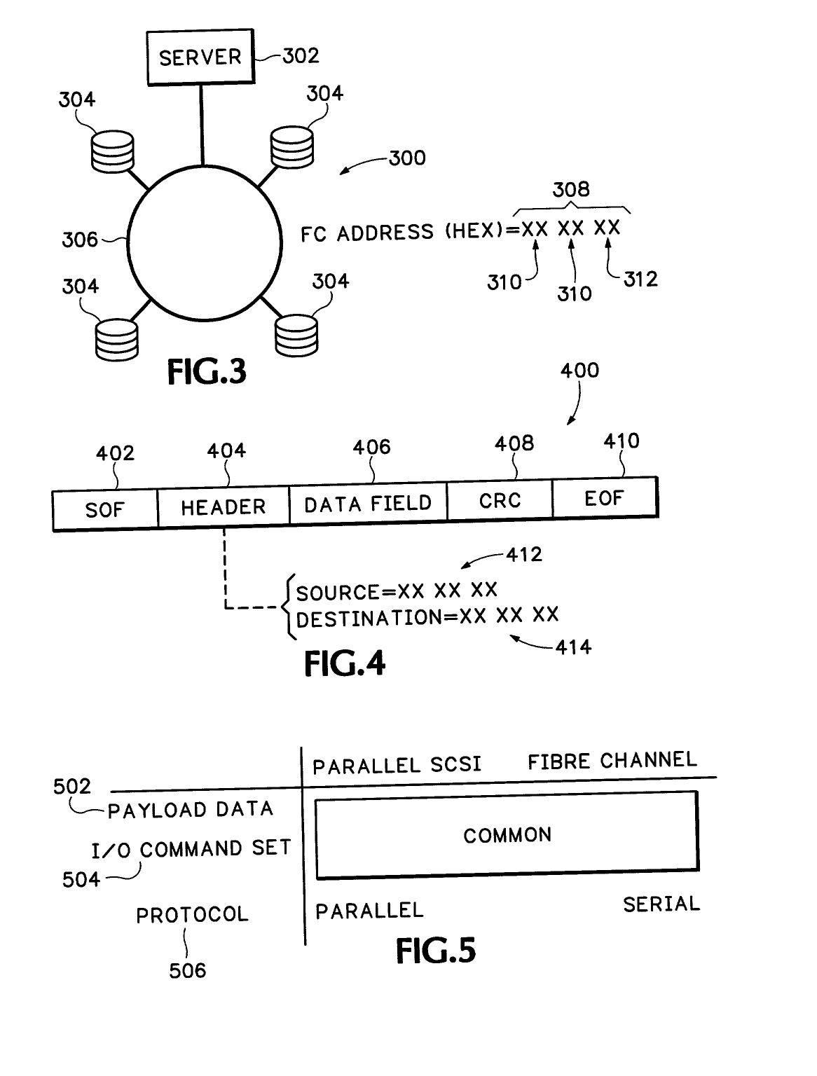

Fibre channel topologies include, in order of increasing complexity, point-to-point, fibre channel arbitrated loop (“FC-AL”), and fabric-based topologies, with FC-AL being the most commonly employed. FIGS. 3 and 4 respectively depict an FC network including an FC-AL, and an exemplary FC frame. As seen in FIG. 3, fibre channel network 300 includes an initiator device, such as server 302, and a number of target devices, such as storage devices 304. The initiator and target devices are interconnected via coupling of the devices to an FC transport medium, such as FC-AL 306.

In the depicted fibre channel system, and in FC generally, devices are identified using a three-byte FC address, which is somewhat analogous in function to the SCSI-IDs discussed above. One of target devices 304, for example, is indicated as being identified with such a three-byte FC address 308. For purposes of illustration, assume the depicted system is part of a larger FC environment, including multiple interconnected FC-AL's. Address 308 includes two upper bytes 310, which are referred to as public bytes and which identify FC-AL 306 within the larger FC network. Public bytes 310 identify the whole FC-AL 306, and thus are the same for each device on the loop (i.e. initiator device 302 and target devices 304). Devices connected to other FC-AL's within the system would be addressed with public bytes having different values. Lower byte 312 is referred to as the private byte and, in contrast to the public byte, is different for each of the devices connected to FC-AL 306. The lower bytes thus serve to uniquely identify the initiator and target devices on FC-AL 306.

Exemplary fibre channel frame 400 includes a SOF (start-of-frame) delimiter 402, header 404, data field 406, CRC (cyclic redundancy check) 408 and EOF (end-of-frame) delimiter 410. Fibre channel communications are conceptually organized into various levels, including bits at the lowest organizational level, then frames composed of a grouping of bits, sequences composed of a series of frames, and, at the highest organizational level, exchanges composed of a series of sequences. Frames may be considered the fundamental unit of data in FC communication. The beginning of exemplary FC frame 400 is marked with SOF delimiter 402. The next field is header 404, which includes, in part, addressing information such as source address 412 and destination address 414. Source address 412 and destination address 414 correspond to FC addresses for particular devices within an FC system, for example to the FC addresses discussed above for the initiator and target devices connected to FC-AL 306. Data field 406 includes the actual data or commands packaged within frame 400, for example payload data to be written to one of storage devices 304. CRC 408 provides error checking, and EOF delimiter 410 marks the end of the frame.

A fundamental difference between the physical architectures defined by parallel SCSI and the FC architecture is that parallel SCSI involves parallel transmission of data on multiple lines, while FC is a serial transmission system. One way of thinking about these two very different architectures is in terms of a layered communications model, similar to the OSI or TCP/IP models commonly used to describe network communications. The OSI and TCP/IP models include a number of hierarchically organized layers. The “highest” layers describe processes and ways of packaging and transmitting data that are independent of any “low level” implementation details, for example issues associated with moving raw bits over a particular physical medium. The lower layers, on the other hand, are primarily concerned with low-level details, and implementations at the lower layers accordingly vary with the particular physical architecture used to transport data.

This concept is illustrated for the present setting by the table shown in FIG. 5, which compares high-level and low-level characteristics of the parallel SCSI and FC architectures. The left-most column includes various aspects to be compared between the two architectures, including payload data 502, high-level I/O command set 504 and protocol 506. Payload data 502 and high-level I/O command set 504 are high-level, architecture-independent issues associated with communication between computer systems and mass storage devices. As shown in the table, payload data 502 and I/O command set 504 are common to both parallel SCSI and FC. An example of payload data would be the actual data (e.g., data encapsulated with data field 406 of frame 400 in FIG. 4) to be written to a mass storage device such as a disk drive. This data is architecture-independent, and thus would be in the same form regardless of whether the target disk drive was coupled to a parallel SCSI bus or to an FC-AL. High-level I/O commands, such as those used to perform read transactions, write transactions and other high-level I/O functions, are also independent of the underlying architecture. Indeed, the newest SCSI standard, SCSI-3, includes a high-level SCSI command set having high-level I/O commands. This command set may be employed in the same form on either the parallel SCSI architecture or FC architecture.

Though they are similar at higher levels, the two architectures differ substantially when considered at a low conceptual level. On the SCSI side, low-level considerations include arbitration for control of the bus, signaling, timing considerations, device selection and various other physical and electrical issues associated with transmitting signals on a multi-line parallel I/O bus interconnecting devices in daisy-chain fashion. Fibre channel, by contrast, is a serial transmission system and thus handles low-level interface issues differently. Unlike parallel SCSI, for example, FC does not have a separate line that can be used to carry a clocking signal. Instead, data must be encoded in FC systems using a special algorithm to allow the clocking signal to be embedded within the serial bit stream. These low-level transport and physical issues are referred to generally as protocols, and vary between parallel SCSI and FC physical architectures, as seen in FIG. 5. Parallel SCSI uses parallel protocols, while FC uses serial protocols.

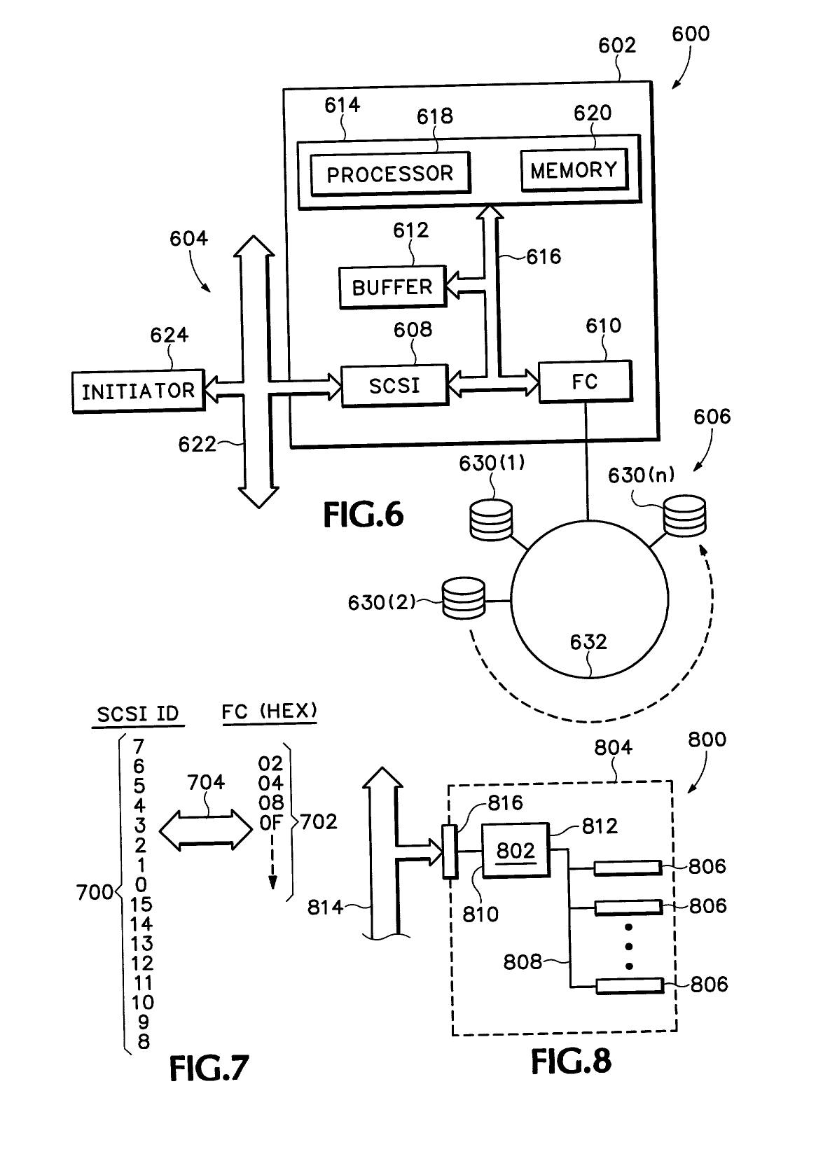

FIG. 6 depicts a storage system 600 according to the present invention, including a SCSI-to-fibre channel gateway 602 operatively coupled between a parallel SCSI system 604 and an FC system 606. As will be explained, gateway 602 is configured to permit initiator devices on parallel SCSI system 604 to access FC target devices on FC system 606. Accordingly, gateway 602 may be considered as having a “front” or “initiator” side, corresponding to the parallel SCSI system on the left side of the figure, and a “back” or “target” side, corresponding to the targeted FC system on the right. As indicated, gateway 602 includes a front-end SCSI controller 608, a back-end FC controller 610, a buffer 612 and a processing system 614, all interconnected via internal bus 616. Processing system 614 may include a processor 618 and a memory 620 configured to perform various functions which will be described.

On the front, or initiator, side of storage system 600, parallel SCSI system 604 includes a parallel SCSI transport medium such as parallel SCSI bus 622. An initiator device 624 is coupled to parallel SCSI bus 622 with a SCSI host adapter as described above. The parallel SCSI bus is coupled with the front end of SCSI-to-fibre channel gateway 602 via front-end SCSI controller 608. The back, or target, side of storage system 600 includes a number of target storage devices 630(1)-630(n) coupled to a fibre channel transport medium such as FC-AL 632. FC-AL 632, in turn, is coupled to gateway 602 via back-end FC controller 610. Consistent with the naming convention above, devices such as initiator 624 that are physically coupled to parallel SCSI bus 622 will variously be referred to as front-end devices, front-side devices, or initiator devices. “Physically coupled” means that the device is directly attached to parallel SCSI bus 622 via a SCSI controller or like mechanism. For example, initiator 624 is physically coupled to parallel SCSI bus 622, but is not physically coupled to FC-AL 632. Initiator 624 may instead be “logically coupled” to FC-AL 632, and thus to the devices on loop 632, as will be explained. The same naming/terminology conventions apply to FC-AL 632. That is, devices physically coupled to FC-AL 632 (e.g., storage devices 630(1)-630(n)) will be referred to as back-end devices, back-side devices, or target devices.

Gateway 602 is operationally configured to permit parallel SCSI initiator devices coupled to parallel SCSI bus 622 to access and communicate with FC target devices coupled to FC-AL 632. Access to the back-end target devices is accomplished by maintaining, for a given back-end target device, two different identifiers. One of the identifiers is associated with the parallel SCSI front end, and the other is associated with the FC back end. A correlation, such as a mapping relationship, is created between the two identifiers. Typically, the correlating information is maintained by processing system 614 of gateway 602. The correlating information is used by the gateway to provide SCSI initiators coupled to parallel SCSI bus 622 with logical access to FC targets coupled to fibre channel arbitrated loop 632. To effect this logical access, gateway 602 typically communicates with parallel SCSI bus 622, and thus with any front-end devices coupled to bus 622, so that the back-end target devices appear to be SCSI targets coupled to the parallel SCSI bus, even though they are in fact actually physically coupled to fibre channel arbitrated loop 632.

FIG. 7 illustrates an example of the correlation, or mapping, which may be used by gateway 602 to provide front-end parallel SCSI initiators with logical access to back-end FC targets. The first column includes front-end identifiers such as SCSI-IDs 700, which are associated with devices on the front end of gateway 602 (e.g., SCSI initiator 624). The SCSI-IDs in the depicted example reflect those available in SCSI implementations which support up to 15 devices and a host adapter on a single parallel SCSI bus. The SCSI-IDs are listed in descending order of priority, with 7 being the highest priority. By convention, SCSI-ID-7 is assigned by default to the SCSI host adapter controlling the parallel SCSI bus. SCSI-ID-7 would thus not normally be available for mapping with a back end device. The second column includes one or more back-end identifiers such as FC identifiers 702, which are associated with devices on the back end of gateway 602 (e.g., FC target storage devices 630(1)-630(n)). FC identifiers 702 may include any suitable reference, index or other information which serves to identify and differentiate the various devices on the fibre channel system from one another. For example, in the depicted table, FC identifiers 702 include the private byte component of the three-byte fibre channel address discussed above.

Referring to FIGS. 6 and 7 together, front-end identifiers (e.g., SCSI-IDs 700) identify devices on the front end only, and back-end identifiers (e.g., FC identifiers 702) identify devices on the back end only. In other words, the SCSI-IDs listed in the table have meaning only on the front end of gateway 602 (i.e., on parallel SCSI bus 622). The SCSI-IDs typically are meaningless on the back end of the gateway (i.e., on fibre channel arbitrated loop 632). The converse holds true for the private byte fibre channel addresses shown in the second column—these addresses have meaning only on FC-AL 632 and are not used on parallel SCSI bus 622.

Accordingly, a mapping 704 between the SCSI-IDs and FC addresses is provided for each storage device coupled to FC-AL 632. The mappings are one-to-one, in that each SCSI-ID is correlated with a different one of the FC addresses listed in the second column.

The mapping information discussed above typically is created and maintained by gateway 602. Referring first to the back end of gateway 602, FC addresses may be assigned on FC-AL 632 according to known FC initialization procedures, in which devices on the FC-AL select addresses via a soft-addressing method. Gateway 602 may be configured so that the gateway in general, and back-end FC controller 610 in particular, operates as an FC host relative to the back-end devices coupled to FC-AL 632 (i.e., storage devices 630(1)-630(n)). Accordingly, once addresses are selected on FC-AL 632, the storage devices log in to the gateway, as occurs in known FC login procedures. During this process, back-end FC controller 610 and processing system 614 “discover” the various other devices connected to loop 632 and obtain configuration information for those devices, including FC addresses.

Referring now to the front end identifiers used by gateway 602, the gateway typically is pre-configured for operation with a particular set of SCSI-IDs. One alternative is to reserve one SCSI-ID for a front-end initiator device, while leaving all other SCSI-IDs available for mapping with a back-end device. For example, referring to FIGS. 6 and 7, SCSI-ID-7 would be reserved for initiator 624, and all remaining SCSI-IDs (6, 5, 4, 3, 2, 1, 0, 15, 14, 13, 12, 11, 10, 9, 8) would be available for correlation with a back-end device (e.g., storage devices 630(1)-630(n)) via the back-end identifier for the back-end device. Alternatively, multiple SCSI-IDs could be set aside for multiple SCSI devices physically coupled to parallel SCSI bus 622, thus reducing the number of SCSI-IDs available for mapping with back-end devices. In both of these examples, a pre-determined set of SCSI-IDs is made available to gateway 602 for mapping with a back-end device. Instead, or in addition, SCSI-IDs available for mapping with back-end devices may be obtained through dynamic methods, where gateway 602 sweeps parallel SCSI bus 622 during initialization to obtain unused SCSI-IDs.

Once mapping is completed, gateway 602 is ready to enable front-end initiator devices to logically access back-end devices. For example, assume in FIG. 6 that initiator 624 is assigned SCSI-ID-7. Assume further that the three storage devices 630 shown on FC-AL 632 have private-byte FC addresses 02, 04, and 08, respectively, and that these addresses are respectively mapped by processing system 614 with SCSI-ID-6, SCSI-ID-5, and SCSI-ID-4. At some point, initiator 624 sweeps parallel SCSI bus 622 to discover other devices on the parallel SCSI bus. Gateway 602 responds using the three SCSI-IDs, such that it logically appears to initiator 622 that storage devices 630 are SCSI target devices on the parallel SCSI bus having SCSI-IDs 6, 5 and 4.

Continuing with this example, initiator 624 may then engage in I/O transactions with the back-end target devices via the mapped SCSI-IDs. Gateway 602 is configured to respond to I/O transactions traveling on parallel SCSI bus that target the mapped SCSI-IDs. In such a case, the transaction data is received from parallel SCSI bus 622 via front-end SCSI controller 608, and is processed by processing system 614. This processing includes performing an initiator-to-target protocol conversion to handle the low-level physical/transport details which vary between the parallel SCSI physical architecture and fibre channel system, as discussed above with reference to FIG. 5. This converts the protocol from a parallel protocol associated with the parallel SCSI bus to a serial protocol associated with the fibre channel system. In addition to performing low-level protocol conversion, processing system 614 forwards the high-level components of the I/O transaction (e.g., commands 504 or payload data 502 shown in FIG. 5) onto the back end transport medium (i.e. onto FC-AL 632). Typically, the commands and/or payload data are forwarded onto FC-AL 632 with accompanying addressing information corresponding to the targeted back-end device.

A SCSI-to-fibre channel gateway according to the present invention may be implemented in many different ways. In many cases, it will be desirable to incorporate gateway 602 into a single integrated chip. FIG. 8 depicts such a chip 802, in connection with fibre channel storage system 800. Fibre channel storage system 800 includes an enclosure 804 within which a number of target storage devices, such as FC disks 806, are mounted. FC Disks 806 are coupled to a FC-AL 808, which may be implemented as a backplane or similar arrangement mounted within enclosure 806. As with the previously described SCSI-to-fibre channel gateway 602, chip 802 includes a parallel SCSI front end or initiator side 810, and an FC back end or target side 812. Target side 812 is coupled to FC-AL 808, and initiator side 810 is configured to couple with parallel SCSI bus 814 via a SCSI connector 816 which is accessible from the outside of enclosure 804. Chip 802 is configured similarly to SCSI-to-fibre channel gateway 602, to enable initiator devices on parallel SCSI bus 814 to logically access FC disks 806, even though they are employed within a different physical topology/architecture, namely the serial-based FC architecture.

The gateway systems described above in accordance with the present invention provide a number of advantages over existing FC-to-SCSI multiplexers. Notably, the systems described with reference to FIGS. 6, 7 and 8 provide system designers with additional options for upgrading mass storage systems. Conventional FC-to-SCSI multiplexers are designed assuming that target storage devices will SCSI devices provided within a parallel SCSI architecture, and that initiating side technology will be fibre channel. In many cases, this is a desirable alternative to a complete shift to FC technology. However, in many other cases, system users may desire to install FC target-side devices while continuing to run parallel SCSI initiators. The SCSI-to-fibre channel gateways and storage systems of the present invention allow for more flexible upgrades, by providing a mechanism to enable logical access from a SCSI initiator to target devices coupled to a fibre channel transport medium.

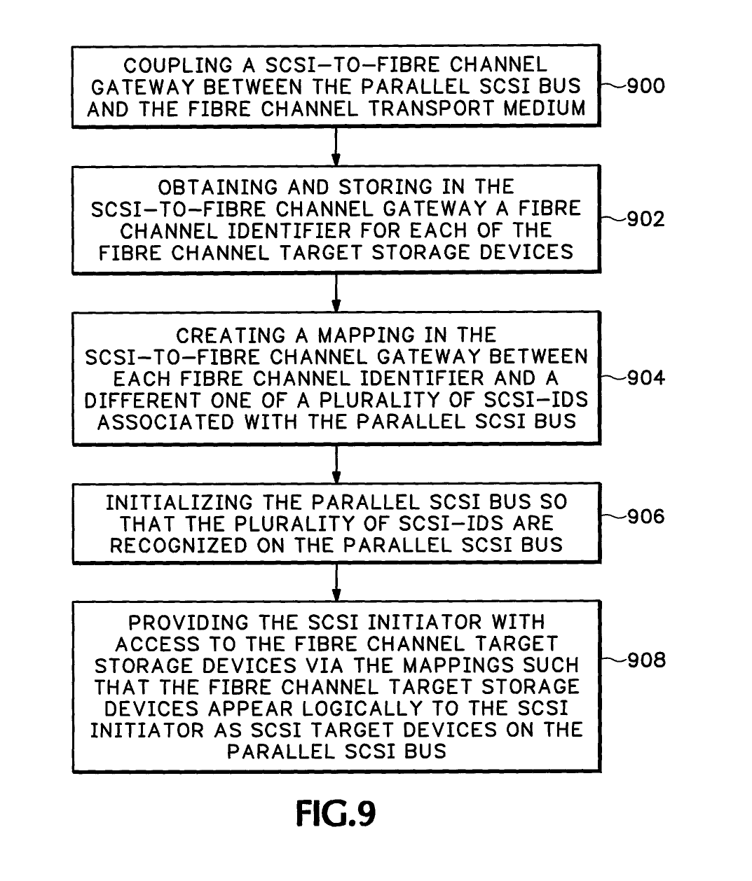

It should be further appreciated that the invention includes a method for logically access FC target storage devices coupled to an FC transport medium with a SCSI initiator coupled to a parallel SCSI bus. FIG. 9 depicts an example of such a method, which provides advantages and benefits similar to those just discussed. At 900, the method includes coupling a SCSI-to-fibre channel gateway between the parallel SCSI bus and the fibre channel transport medium. At 902, the method includes obtaining and storing, in the SCSI-to-fibre channel gateway, a fibre channel identifier for each of the fibre channel target storage devices. At 904, the method includes creating a mapping in the SCSI-to-fibre channel gateway between each fibre channel identifier and a different one of a plurality of SCSI-IDs associated with the parallel SCSI bus. At 906, the method includes initializing the parallel SCSI bus so that the plurality of SCSI-IDs are recognized on the parallel SCSI bus. Finally, at 908, the method includes providing the SCSI initiator with access to the fibre channel target storage devices via the mappings such that the fibre channel target storage devices appear logically to the SCSI initiator as SCSI target devices on the parallel SCSI bus.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

I claim:

1. A SCSI-to-fibre channel gateway configured to permit a SCSI initiator on a parallel SCSI bus to communicate with a fibre channel target on a fibre channel transport medium, comprising:
a front-end SCSI controller configured to operatively couple the SCSI-to-fibre channel gateway with the parallel SCSI bus;
a back-end fibre channel controller configured to operatively couple the SCSI-to-fibre channel gateway with the fibre channel transport medium; and
a processing system coupled with the front-end SCSI controller and the back-end fibre channel controller, the processing system being configured to:
maintain a fibre channel identifier for the fibre channel target; and
create a mapping between the fibre channel identifier and a SCSI-ID associated with the parallel SCSI bus, where the SCSI-to-fibre channel gateway is configured to use the mapping when communicating with the SCSI initiator to cause the fibre channel target to logically appear to the SCSI initiator as a SCSI target on the parallel SCSI bus.

2. The SCSI-to-fibre channel gateway of claim 1, where the fibre channel identifier includes a fibre channel address for the fibre channel target.

3. The SCSI-to-fibre channel gateway of claim 2, where the processing system is configured to obtain the fibre channel address via the back-end fibre channel controller.

4. The SCSI-to-fibre channel gateway of claim 1, where the processing system is further configured to use the mapping to forward data received via the front-end SCSI controller out the back-end fibre channel controller and onto the fibre channel transport medium if such data targets the SCSI-ID.

5. The SCSI-to-fibre channel gateway of claim 1, where the processing system is configured to perform an initiator-to-target translation from a parallel SCSI protocol to a serial protocol associated with the fibre channel transport medium.

6. The SCSI-to-fibre channel gateway of claim 1, where the back-end fibre channel controller is configured to operatively couple the SCSI-to-fibre channel gateway with a fibre channel arbitrated loop included with the fibre channel transport medium.

7. The SCSI-to-fibre channel gateway of claim 1, where the processing system is configured to create multiple mappings, enabling a plurality of fibre channel targets on the fibre channel transport medium to logically appear to the SCSI initiator as distinct SCSI targets on the parallel SCSI bus.

8. The SCSI-to-fibre channel gateway of claim 1, where the front-end SCSI controller, back-end fibre channel controller and processing system are provided on a single chip.

9. A fibre channel storage system configured to be accessible from a SCSI initiator on a parallel SCSI bus, comprising:
a fibre channel transport medium;
a plurality of fibre channel target storage devices coupled with the fibre channel transport medium; and
a SCSI-to-fibre channel gateway operatively coupled with the fibre channel transport medium and configured to be operatively coupled with the parallel SCSI bus, the SCSI-to-fibre channel gateway being configured to:
maintain a fibre channel identifier for each of the fibre channel target storage devices; and
create a mapping between the fibre channel identifiers and a plurality of SCSI-IDs associated with the parallel SCSI bus, where the SCSI-to-fibre channel gateway is configured to use the mapping when communicating with the SCSI initiator to cause the fibre channel target storage devices to logically appear to the SCSI initiator as a plurality of distinct SCSI targets on the parallel SCSI bus.

10. The fibre channel storage system of claim 9, where the fibre channel identifiers include fibre channel addresses for the fibre channel target storage devices.

11. The fibre channel storage system of claim 10, where the SCSI-to-fibre channel gateway is configured to obtain the fibre channel addresses via the fibre channel transport medium.

12. The fibre channel storage system of claim 9, where the SCSI-to-fibre channel gateway is configured to perform an initiator-to-target translation from a parallel SCSI protocol to a serial protocol associated with the fibre channel transport medium.

13. The fibre channel storage system of claim 9, where the SCSI-to-fibre channel gateway comprises:
a front-end SCSI controller configured to operatively couple the SCSI-to-fibre channel gateway with the parallel SCSI bus;
a back-end fibre channel controller operatively coupled with the fibre channel transport medium; and
a processing system coupled with the front-end SCSI controller and the back-end fibre channel controller.

14. The fibre channel storage system of claim 13, where the front-end SCSI controller, back-end fibre channel controller and processing system are provided on a single chip.

15. The fibre channel storage system of claim 9, where the fibre channel transport medium includes a fibre channel arbitrated loop.

16. The fibre channel storage system of claim 9, further comprising an enclosure within which are mounted the fibre channel transport medium, fibre channel target storage devices, and SCSI-to-fibre channel gateway.

17. The fibre channel storage system of claim 16, further comprising a SCSI connector coupled to the SCSI-to-fibre channel gateway, the SCSI connector having a portion accessible from outside the enclosure and configured to couple the SCSI-to-fibre channel gateway to the parallel SCSI bus.

18. A method of logically accessing fibre channel target storage devices coupled to a fibre channel transport medium using a SCSI initiator coupled to a parallel SCSI bus, comprising:
coupling a SCSI-to-fibre channel gateway between the parallel SCSI bus and the fibre channel transport medium;
obtaining and storing, in the SCSI-to-fibre channel gateway, a fibre channel identifier for each of the fibre channel target storage devices;
creating a mapping in the SCSI-to-fibre channel gateway between each fibre channel identifier and a different one of a plurality of SCSI-IDs associated with the parallel SCSI bus;
initializing the parallel SCSI bus so that the plurality of SCSI-IDs are recognized on the parallel SCSI bus; and
providing the SCSI initiator with access to the fibre channel target storage devices via the mappings such that the fibre channel target storage devices appear logically to the SCSI initiator as SCSI target devices on the parallel SCSI bus.
